(19) United States
(12) Patent Application Publication
(10) Pub. No.: US 2002/0172101 A1
(43) Pub. Date: Nov. 21, 2002

(54) Digital and analog sound-signal broadcaster

(76) Inventor: Han-Chih Liu, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/858,607

(22) Filed: May 17, 2001

(51) Int. Cl. G11B 7/00

(52) U.S. Cl. 369/2; 369/53.28; 369/5; 369/6

(57) ABSTRACT

A digital and analog sound-signal broadcaster includes a turntable controllable by a user in its rotating speed and direction, and a traditional plastic record or a special record to be placed on the turntable. A user can also control music data of a CD to be stored in a dynamic memory chip, broadcasting a variety of special sound effects, bringing forth joy, pleasure and glamorous atmosphere. Thus the digital and analog sound-signal broadcaster can broadcast separately music from a traditional plastic record and that from a CD with easy operation.

### BACKGROUND OF THE INVENTION

This invention relates to a digital and analog sound-signal broadcaster, particularly to one capable to apply to a traditional record and to a CD as well, for DJs to modulate special sound effects by controlling rotating speed and direction, having a variety of using options.

Conventionally, on an occasion like a pub, a dancing party, a concert or the like, a DJ makes various special sound effects while broadcasting music by controlling records to rotate clockwise or counterclockwise and regulate its rotating sped by hands in order to heighten atmosphere of joy, but such a way of handling by hands has some disadvantages as below.

1. A conventional plastic record cannot contain many songs for preparing enough music for broadcasting. So a large number of records have to be prepared in advance, inconvenient in carrying and handling.

2. It is not easy to directly pick out a song a DJ wants in a traditional record without experience, inconvenient in the process of broadcasting.

### SUMMARY OF THE INVENTION

A main objective of the invention is to offer a digital and analog sound-signal broadcaster having a traditional record pickup connected to a analog/digital converter for not only using traditional records for broadcasting but using wide popular CDs at present, by means of a dynamic memory chip for receiving signals coming from a laser pickup, applicable both to traditional records and CDs.

Another objective of the invention is to offer an analog and digital sound-signal broadcaster, which contains a control faceplate capable to control a traditional record turntable in its rotating speed and direction, also to control song selection and selecting sound condition. Then an operator can make use of the control faceplate to select songs and moderate sound effects as well.

### BRIEF DESCRIPTION OF THE DRAWINGS

This invention will be better understood by referring to the accompanying drawings, wherein:

FIG. 1 is a block diagram of the electronic circuit of an analog and digital sound-signal broadcaster of the present invention.

FIG. 2 is a cross-sectional view of a pickup needle fitting in a pit of a record to sensing sound of the present invention.

FIG. 3 is a diagram of the first signal judging of timing of the present invention.

FIG. 4 is a diagram of the second signal judging of timing of the present invention.

FIG. 5 is a diagram of the third signal judging of timing of the present invention.

FIG. 6 is a diagram of the fourth signal judging of timing of the present invention.

### DETAILED DESCRIPTION OF THE PREFERRED EMBODIMENT

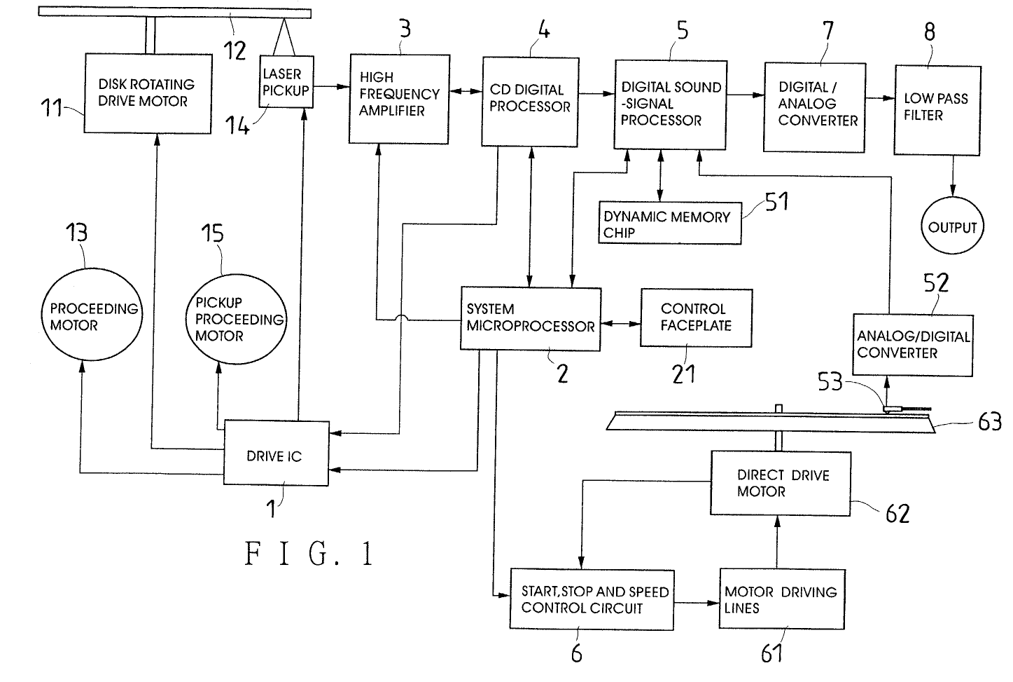

A digital and analog sound-signal broadcaster in the present invention, as shown in FIG. 1, includes a plurality of electronic circuits, which are well known arts, not described here.

The main improvement of a digital and analog sound-signal broadcaster in the invention is as follows. It includes a disc tray 12 for placing on a CD combined with a disc drive motor 11 controlled by a drive IC 1, and a proceeding motor 13 controlled by the drive IC 1 for moving out and in the disc tray 12. When a system microprocessor 2 starts, it controls a high frequency amplifier 3 to turn on a laser light, and controls a CD digital processor 4 to turn on a laser pickup 14 via the drive IC 1. The laser pickup 14 is moved by a pickup proceeding motor 15 controlled by the drive IC 1, transmitting a signal to the CD processor 4 through the high frequency amplifier 3. Then the CD digital processor 4 informs the system microprocessor 2 if light focus is successful or not. In case of failure, all actions are to be stopped, and in case of success, the system microprocessor 2 at once controls the digital processor 4 to let the CD on the disc tray 12 rotate at double speed. Then the laser pickup 14 reads the music data in the CD, which is then transmitted to the system microprocessor 2 and a digital sound-signal processor 5 via the high frequency amplifier 3 and the CD digital processor 4. So the system microprocessor 2 displays information of the CD on the control faceplate 21, and the digital sound-signal processor 5 stores the music data of the CD in the dynamic memory chip 51.

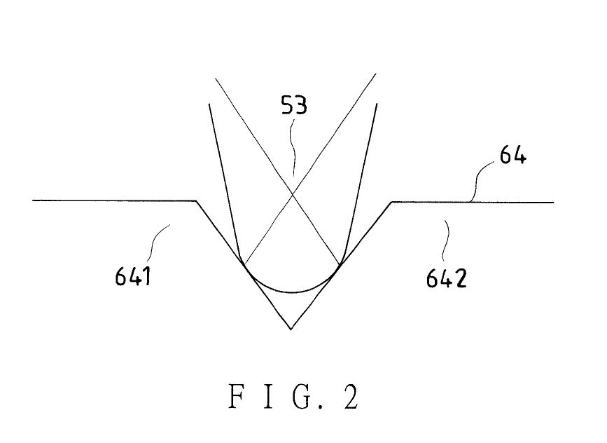

When the digital and analog sound-signal broadcaster is used to broadcast music, a traditional record is directly placed on a turntable 63, which is then controlled to rotate, stop or in rotating direction and speed by a drive motor 62 controlled by a motor drive line 61 controlled by a control circuit 6. Or a CD is placed on the direct disc tray 12 and a special record 64 of continual analog signals on the turntable 63 (with FIG. 2 referred to). At this time, the operator puts in necessary action through the control faceplate 21, which transmits it into the system microprocessor 2. After the system microprocessor 2 receives the command, it controls start, stop, rotating direction and speed of the turntable 63, and the digital sound-signal processor 5 decides to store the music data in the dynamic memory chip 51 according to the condition of the control faceplate received by the system microprocessor 2 and the data of the traditional plastic record or a special record 64 on the turntable 63 read from the pickup needle 53 connected to the analog/digital converter, or treats directly the music data of the traditional plastic record and songs to be broadcast, rotating speed and direction by means of the digital/analog converter 7 and broadcasts music with filtered wave by the low pass filter 8.

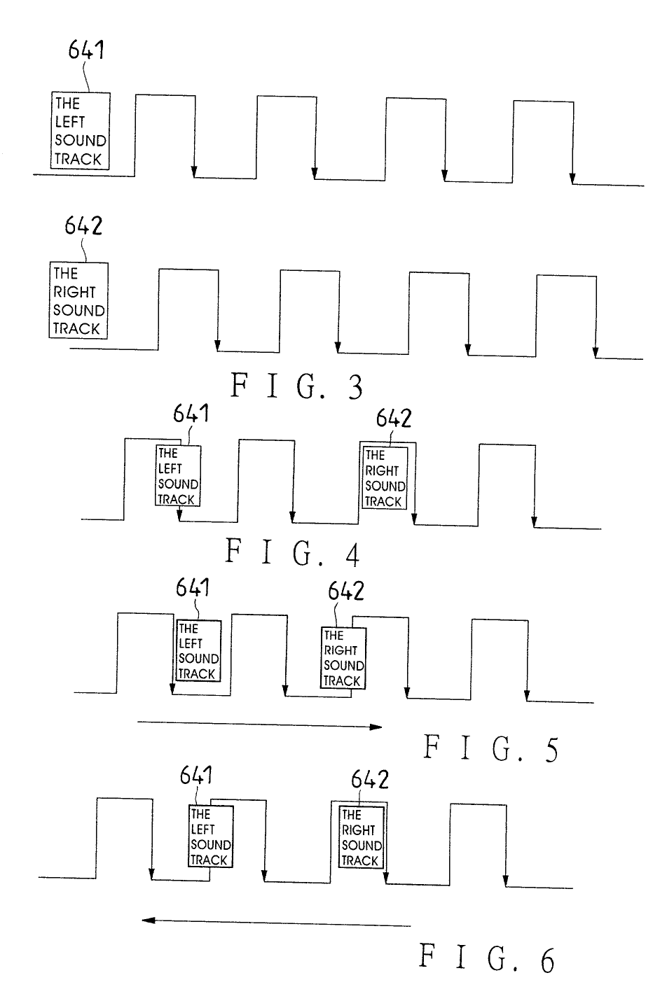

Next, as shown in FIGS. 2 and 3, the special record 64 contains continual analog signals recorded with a certain frequency between 50 Hz-20 KHz, and the signals have 90 degrees of phase difference between a left sound track and a right sound track so as to show the rotating speed and direction of the special record 64. In case of the turntable stopping with no movement, the pickup needle 53 senses no continual signals from the left or the right sound track 641 or 642 of the special record 64, with no movement produced as shown in FIG. 3.

When the turntable 63 turns rightwards, the left sound track 641 may detect and trigger signals, so the system microprocessor 2 knows that the turntable 63 rotates rightwards, counting the triggered signals of the left sound-signal track and receives time difference of the next triggered signal, and calculates the rotating speed of the turntable 63 as shown in FIG. 4.

When the turntable 63 turns leftwards, the pickup needle 53 detects and triggers signals to let the system microprocessor 2 know that the turntable 63 rotates leftwards, and counts time difference between two triggered signals of the right sound-signal track 642, calculating the rotating speed of the turntable 63 as shown in FIG. 7. The pickup needle 53 waits next triggered signal and at the same time judges which first reaches the trigger location for deciding whether there is direction and speed change or not, after the system microprocessor 2 finished calculation of the rotating direction and speed.

The digital and analog sound-signal broadcaster in the invention has the following advantages, as understood from the aforesaid description.

1. It cannot merely broadcast traditional records but common CDs, having a variety of selection in use.

2. It can make use of music data stored in common CDs to make various modulated special music, as CDs are light and can store a lot of music data, convenient to use and carry.

3. It has a control faceplate for a user to make selection of songs and modulate special sound effects, and in addition, the control faceplate shows condition of inputs made by the user and information of music data for user to easily handle the broadcaster.

4. It sends data to the digital sound-signal processor with double speed to be stored in the dynamic memory chip, so no matter the special record rotates clockwise or counterclockwise, the digital sound-signal processor can broadcast the music data stored in the dynamic memory chip readily.

What is claimed is:

1. A digital and analog sound-signal broadcaster comprising,
a disc tray placed on a disc drive motor controlled by a drive IC and moved in and out for placing or taking off a CD thereon by a proceeding motor controlled by said drive IC;
a high frequency amplifier turning on a laser light when a system microprocessor starts operation;
a CD digital processor turning on a laser pickup through said drive IC;
said laser pickup moved by a pickup moving motor controlled by said drive IC and transmitting a signal to said CD digital processor via said high frequency amplifier, said CD digital processor informing said system microprocessor of whether laser beam is focused or not, all action of all components stopping in case of focus failure, said system microprocessor at once controlling said CD digital processor to start disc drive motor via said drive IC to let said CD on said disc tray rotate at double speed, said laser pickup reading music data stored in said CD while said CD together with said disc tray rotates, said read data transmitted to said system microprocessor and said sound-signal processor via said high frequency amplifier and said CD digital processor, said system microprocessor displaying said data of said CD on said control faceplate, said digital sound-signal processor storing said music date of said CD in said dynamic memory chip;
a traditional plastic record directly placed on a turntable controlled to start, stop and in rotating direction and speed by a direct drive motor connected to a motor drive line controlled by a star, stop and speed control motor, or a CD placed on said disc tray and a special record placed on said turntable;
an operator putting in necessary action through said control faceplate, said necessary action transmitted in said system microprocessor, said system microprocessor controlling said turntable in starting, stopping and rotating direction and speed after received a command, said digital sound-signal processor deciding music data to be stored in said dynamic memory chip according to a condition on said control faceplate received by said system microprocessor and according to said data of said traditional plastic record or said special record on said turntable controlled to rotate by said faceplate by an operator, said pickup connected to said analog/digital converter reading said data, or said system microprocessor directly disposing music data stored in said traditional plastic record, songs to be broadcast and rotating speed and direction, said music broadcast with filtered wave through a low pass filter after said digital/analog converter converts said music data into analog data;
said digital and analog sound-signal broadcaster capable not merely to broadcast music data stored in traditional plastic records, but also to broadcast music date stored in common CDs.

2. The digital and analog sound-signal broadcaster as claimed in claim 1, wherein said special record able to be placed on said turntable has all data stored in constant continual analog signals.

3. The digital and analog sound-signal broadcaster as claimed in claim 2, wherein said constant continual analog signals stored in said special record has a certain frequency between 50 Hz-20 KHz.
